(19) United States
(12) Patent Application Publication
(10) Pub. No.: US 2023/0004222 A1
(43) Pub. Date: Jan. 5, 2023

(54) PROVIDING INPUTS TO COMPUTING DEVICES

(71) Applicant: Hewlett-Packard Development Company, L.P., Spring, TX (US)

(72) Inventor: Hsiang-Ta Ke, Taipei City (TW)

(21) Appl. No.: 17/779,931

(22) PCT Filed: Nov. 27, 2019
(86) PCT No.: PCT/US2019/063713

§ 371 Date: May 25, 2022

(51) Int. Cl. G06F 3/01; G06F 3/147; G06F 3/0487

(52) U.S. Cl. CPC G06F 3/015; G06F 3/147; G06F 3/013; G06F 3/0487

(57) ABSTRACT

Techniques for providing inputs to computing devices are described. In an example, a computing device may display an input interface based on a gaze of a user. The input interface may comprise a plurality of keys, each of which is selectable by the user to provide an input to the computing device. Based on a gaze of the user at a key, the computing device may determine that the user has selected the key and perform an action corresponding to the selected key.

### BACKGROUND

Inputs may be provided to computing devices, such as laptops, desktops, mobile devices, and tablets, using input devices, such as a keyboard, mouse, joystick, touchscreen, and gamepad.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a computing device to receive an input from a user, according to an example implementation of the present subject matter;

FIG. 2 illustrates identification of a request of a user to provide an input to a computing device, according to an example implementation of the present subject matter;

FIG. 3 illustrates a computing device receiving an input from a user and performing an action corresponding to the input, according to an example implementation of the present subject matter;

FIG. 4 illustrates a method to receive an input from the user, according to an example implementation of the present subject matter; and

FIG. 5 illustrates a computing environment, implementing a non-transitory computer-readable medium to receive an input from the user, according to an example implementation of the present subject matter.

### DETAILED DESCRIPTION

Computing devices, such as laptops, desktops, Automatic Teller Machines (ATMs), and the like, may involve usage of physical or virtual input devices, such as a physical keyboard, virtual keyboard, joystick and mouse, to receive inputs from users. However, a user may have to use his hands or voice commands to provide the inputs. For instance, to provide a textual input to a computing device, the user may have to type on a keyboard or select keys on a virtual keyboard using a mouse. Such input methods may not be usable in some cases. For example, people with physical disabilities may not be able to provide inputs to computing devices using hand or voice commands.

The present subject matter relates to providing inputs to computing devices. In accordance with the present subject matter, an input may be received by a computing device based on a brain wave signal, such as a Steady-state visual evoked potential (SSVEP) signal, which may be generated in the brain of a user in response to the user gazing at a flickering visual stimulus. For instance, when a user gazes at a flickering visual stimulus, a voltage may be generated in the occipital lobe of the brain of the user. This voltage may be sensed and used to determine an input being provided to the computing device.

In accordance with an example implementation, a computing device may identify a request of a user to display an input interface based on receipt of a first signal. The first signal may be received in response to a gaze of the user at a predetermined region of the computing device. The input interface may be utilized to provide an input to the computing device. The predetermined region may comprise, for example, a light emitting Diode (LED) flickering at a predetermined frequency (hereinafter referred to as the first frequency) and the user may gaze at the LED if he intends to provide input to the computing device using the input interface. The input to be provided may be, for example, a textual input.

When the user gazes at the LED, a brain wave signal (hereinafter referred to as the first brain wave signal) having a dominant frequency may be sensed by set of electrodes. The set of electrodes may be, for example, Electroencephalogram (EEG) electrodes, placed on the head of the user. The set of electrodes may be connected to a sensing device to transmit the sensed first brain wave signal to the sensing device. The sensing device may receive the first brain wave signal from the set of electrodes and may generate a corresponding signal (hereinafter referred to as first signal), for example, by amplifying, filtering, and digitizing the first brain wave signal. The computing device may receive the first signal. To identify that the user has requested to display the input interface based on the first signal, the processing unit may obtain the dominant frequency of the first brain wave signal from the first signal and compare the dominant frequency of the first brain wave signal and the first frequency.

Based on the identification, the input interface may be generated for display by a display device of the computing device. The input interface may comprise a plurality of images, which may be images of keys of a virtual keypad, interchangeably referred to as the keypad. The virtual keypad may be, for example, a virtual alphanumeric keyboard, interchangeably referred to as the keyboard. Each key may flicker at a flickering frequency different from flickering frequencies of other keys. For instance, while an “A” key may flicker at 25 Hz, a “B” key may flicker at 26 Hz.

To provide an input to the computing device using the keypad (i.e., to select a key on the keypad), the user may gaze at a key. For instance, to type the letter “A”, the user may gaze at the “A” key. When the user gazes at a key, a corresponding brain wave signal (hereinafter referred to as the second brain wave signal) may be generated by the brain of the user. The computing device may receive a second signal corresponding to the second brain wave signal from the sensing device and determine the key that the user has gazed at based on the second signal. For the determination, the processing unit may obtain a dominant frequency of the second brain wave signal from the second signal. The dominant frequency of the second brain wave signal may then be compared with flickering frequencies of the keys of the keypad and a key having a flickering frequency matching the dominant frequency of the second brain wave signal is identified. The identified key may be determined as the key at which the user gazed.

Subsequently, an action corresponding to the selection of the determined key may be performed. For instance, if it is determined that the user has gazed at the “A” key, the letter “A” may be displayed on the display device.

The present subject matter provides an efficient and reliable technique to provide inputs to computing devices. For instance, since the present subject matter allows receiving inputs by computing devices based on brain wave signals of a user, the present subject matter eliminates the usage of input devices, such as a keyboard. Further, the usage of hands for providing inputs to computing devices can be obviated.

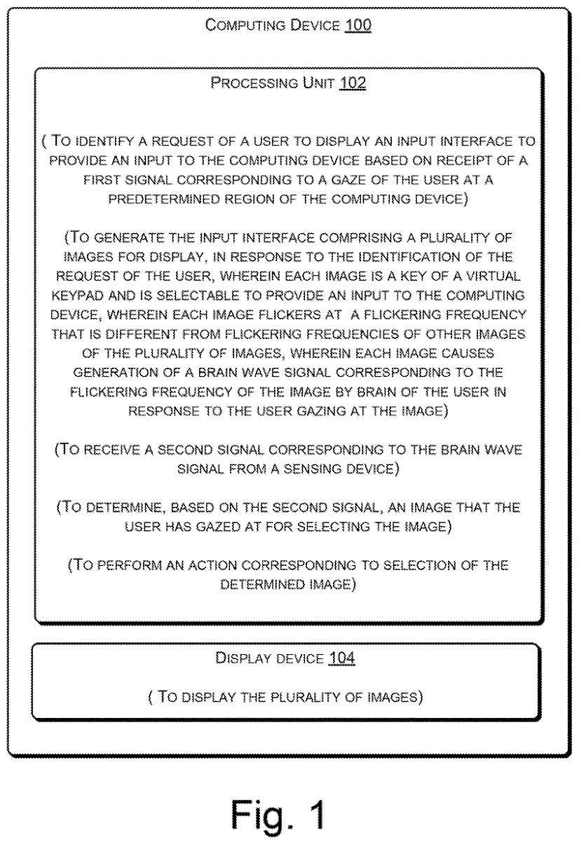

The present subject matter is further described with reference to FIGS. 1-6. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a computing device 100 to receive an input from a user (not shown in FIG. 1), according to an example implementation of the present subject matter. The computing device 100 may be, for example, a laptop, a desktop, a tablet, a mobile phone, or the like. The computing device 100 may comprise a processing unit 102.

The processing unit 102, may include, for example, a microprocessor, a microcomputer, a microcontroller, a digital signal processor, a central processing unit, a state machine, a logic circuitry, or a device that manipulates signals based on operational instructions. Among other capabilities, the processing unit 102 may fetch and execute computer-readable instructions stored in a memory (not shown in FIG. 1), such as a volatile memory or a non-volatile memory, of the computing device 100.

In an example, the processing unit 102 may identify a request of the user to display an input interface to provide an input to the computing device 100 based on receipt of a first signal. The first signal may correspond to a gaze of the user at a predetermined region of the computing device 100. For instance, the predetermined region may comprise a light emitting diode (LED) (not shown in FIG. 1) flickering at a predetermined frequency (hereinafter referred to as the first frequency). The processing unit 102 may identify the request of the user based on the gaze of the user at the LED, as will be explained below:

The gazing at the LED may induce a brain wave signal in the brain of the user (hereinafter referred to as the first brain wave signal). The first brain wave signal may be sensed by a set of electrodes (not shown in FIG. 1), which may be, for example, an Electroencephalogram (EEG) electrodes, which may be placed on the head of the user. A sensing device (not shown in FIG. 1) connected to the set of electrodes may generate the first signal corresponding to the first brain wave signal, for example, by amplifying, filtering, and digitizing the first brain wave signal. Accordingly, the sensing device may comprise an amplifier, a filter, and an analog-to-digital (A/D) converter to generate the first signal.

As mentioned earlier, the processing unit 102 may identify the request of the user based on the first signal. For the identification, the processing unit 102 may receive the first signal from the sensing device. Further, the processing unit 102 may process the first signal to obtain a dominant frequency of the first brain wave signal. The processing unit 102 may then compare the dominant frequency of the first brain wave signal and the first frequency to identify the request of the user. For instance, if the dominant frequency of the first brain wave signal equals the first frequency, the user request to provide input to the computing device 100 may be identified.

In response to the identification of the request of the user, the processing unit 102 may generate the input interface, which may comprise a plurality of images for display. The display device 104 may be part of the computing device 100, which can display the generated plurality of images. The display device 104 may be, for example, a Liquid Crystal Display (LCD) display, an LED display, an organic-LED (OLED) display, or an electronic ink display. In an example, the images may be images of keys of a virtual keypad, such as a virtual alphanumeric keyboard. Each image may flicker at a flickering frequency different from flickering frequencies of other keys. In an example, each image may flicker at a flickering frequency equal to or greater than 25 Hz, thereby preventing the user from perceiving the flicker. Accordingly, a discomfort caused to the user by perception of flicker is prevented.

To provide input to the computing device 100 using the input interface, the user may gaze at an image of the input interface. For instance, to type the letter “A”, the user may gaze at the image of a key “A” on the keypad. When the user gazes at an image, a corresponding brain wave signal may be generated by the brain of the user. A brain wave signal generated based on gazing at an image of the keypad may be referred to as the second brain wave signal. The second brain wave signal may be sensed by the set of electrodes and the sensing device may receive the second brain wave signal from the set of electrodes. Then, the sensing device may generate a signal (hereinafter referred to as the second signal) corresponding to the second brain wave signal.

The processing unit 102 may receive the second signal from the sensing device and based on the second signal, the processing unit 102 may determine the image that the user has gazed at for selecting the image. For the determination, the processing unit 102 may obtain a dominant frequency of the second brain wave signal from the second signal. The processing unit 102 may compare the dominant frequency of the second brain wave signal with the flickering frequency of the keys of the keypad and identify a key having a flickering frequency matching the dominant frequency of the second brain wave signal. For example, if the dominant frequency of the second brain wave signal is obtained as 26 Hz and a flickering frequency of a “B” key is 26 Hz, then the processing unit 102 may identify the “B” key as the key having the flickering frequency matching with the dominant frequency of the second brain wave signal. The identified key may be determined as the key at which the user gazed.

Subsequently, an action may be performed by the processing unit 102 corresponding to the selection of the determined image. For instance, if it is determined that the user has gazed at the “A” key, the processing unit 102 may generate the letter “A” to be displayed on the display device 104. The various aspects of the present subject matter will be explained in greater detail below:

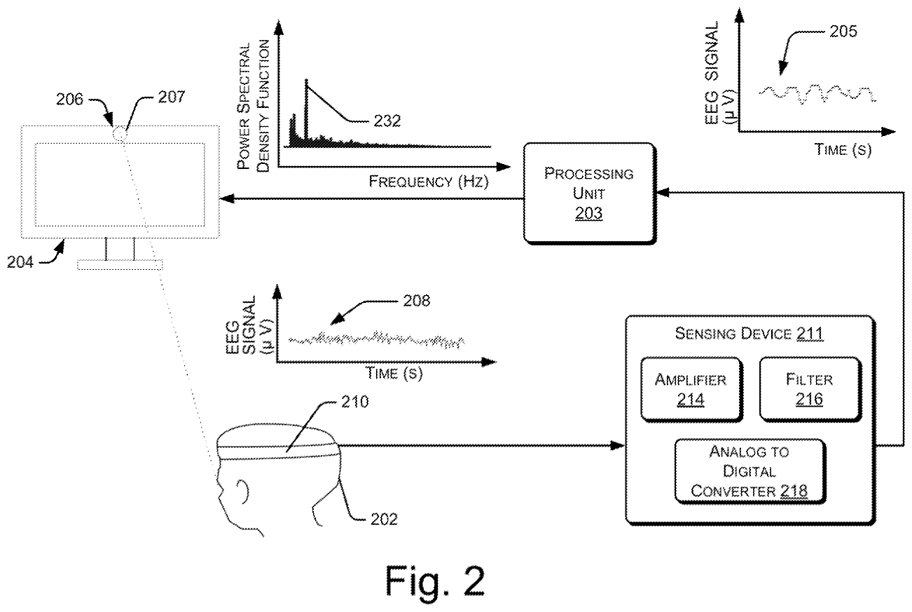

FIG. 2 illustrates identification of a request of a user 202 to provide input to a computing device, according to an example implementation of the present subject matter. The computing device may correspond to the computing device 100 and may be, for example, a desktop or a laptop. Further, the computing device may include a processing unit 203, which corresponds to the processing unit 102, and a display device 204, which corresponds to the display device 104.

The processing unit 203 may identify a request of the user 202 to display an input interface. The user 202 may request for display of the input interface to provide an input to the computing device. The identification of the request of the user 202 may be based on a receipt of a first signal 205 corresponding to a gaze of the user 202 at a predetermined region 206 of the computing device 100. The predetermined region 206 may be part of a bezel of the display device 204.

In an example, the predetermined region 206 may comprise an LED 207 and the identification of request may be based on a receipt of the first signal 205 corresponding to the gaze of the user 202 at the LED 207. To allow identification of the request of the user 202, the LED 207 may flicker at a frequency (hereinafter referred to as “first frequency”). Due to the flickering of the LED 207, when the user 202 gazes at the LED 207, a first brain wave signal 208 may be generated by the brain of the user 202. The first brain wave signal 208 may be generated in an occipital region of the brain. The first brain wave signal 208 may be sensed by a set of electrodes 210. The set of electrodes 210 may be, for example, an Electroencephalogram (EEG) unit coupled to the head of the user 202, as shown in FIG. 2.

The set of electrodes 210 may comprise a plurality of electrodes (not shown in FIG. 2) to sense the first brain wave signal 208. The placement of the electrodes on the head may be in accordance with an International 10-20 system standard. The set of electrodes 210 may be connected to a sensing device 211 to transmit the first brain wave signal 208 to the sensing device 211, which may generate the first signal 205 corresponding to the first brain wave signal 208. The connection between the sensing device 211 and the set of electrodes 210 may be a wired connection or a wireless connection. In an example, the set of electrodes 210 and the sensing device 211 may be a part of an EEG.

In an example, the EEG may be implemented as a headset coupled to the head of the user. In another example, the sensing device 211 may be implemented in the computing device. In such an example, the computing device may receive the first brain wave signal 208 from the set of electrodes 210 and may generate the first signal 205 corresponding to the first brain wave signal 208.

As mentioned earlier, the sensing device 211 may generate the first signal 205 corresponding to the first brain wave signal 208. In an example, the first signal 205 may be generated from the first brain wave signal 208 by the following operations:

The first brain wave signal 208 may be amplified. To perform the amplification, the sensing device 211 may comprise an amplifier 214. Further, the sensing device 211 may comprise a filter 216 to filter the first brain wave signal 208. The filtering may involve filtering out unwanted frequencies, which may correspond to noise, in the first brain wave signal 208. The first brain wave signal 208 may be an analog signal and may have to be converted to a digital signal for processing by the processing unit 203. Accordingly, the sensing device 211 may comprise an analog-to-digital (A/D) converter 218 to obtain the first signal 205. Thus, the first signal 205 may be an amplified, filtered, and a digitized version of the first brain wave signal 208.

In an example, the amplifier 214 and the filter 216 may be a part of a microcontroller and may be programmed using Very High Speed Integrated Circuit Hardware Description Language (VHDL). Further, in an example, the A/D converter 218 may be a complex programmable logic device (CPLD) programmed using VHDL program. Accordingly, the A/D converter 218 may be programmed with pre-loaded configurations to calibrate the A/D converter 218 according to environment of the user 202.

Although the sensing device 211 is said to perform amplification, filtering, and digitization functions, in some examples, the sensing device 211 may additional operations on the first brain wave signal 208 or may lesser operations than the above-mentioned operations to generate the first signal 205. Accordingly, the sensing device 211 includes less or more components.

The sensing device 211 may transmit the generated first signal 205 to the processing unit 203. The connection between the sensing device 211 and the processing unit 203 may be a wired connection or a wireless connection. Further, the processing unit 203 may receive the first signal 205 from the sensing device 211.

The first brain wave signal 208 may comprise a plurality of components, each having a different frequency. Further, each component may have a portion of the energy associated with the first brain wave signal 208, A frequency associated with a component that has a higher energy as compared to all other components is referred to as a dominant frequency 232 of the first brain wave signal 208. The dominant frequency 232 of the first brain wave signal 208 may equal the flickering frequency of the LED 207, i.e., the first frequency. For instance, the component of the first brain wave signal 208 having the dominant frequency 232 may be the component caused by the gazing at the LED 207, The other components, with lesser energies, may correspond to noise.

To identify the request of the user 202 to provide the input, the processing unit 203 may have to determine the dominant frequency 232 of the first brain wave signal 208. To determine the dominant frequency 232 of the first brain wave signal 208, a range of frequencies corresponding to the plurality of components of the first brain wave signal 208 may be identified. In an example, the processing of the first signal 205 may comprise obtaining frequency-domain representation of first signal 205. The frequency-domain representation of the first signal 205 may be a representation of variation of a power spectral density function of the first signal 205 with respect to the range of frequencies. The power spectral density function may be indicative of variation of energy of the first signal 205 with respect to frequency. So, the frequency-domain representation of the first signal 205 may indicate the energy of the first signal 205 for various frequencies in the first signal 205. For instance, the frequency-domain representation may represent that “N %” of energy of the first signal 205 is in frequency “A”, “%” of energy of the first signal 205 is in frequency “B”, and so on.

To obtain the frequency-domain representation of the first signal 205, the processing unit 203 may apply Fast Fourier Transform (FFT) on the first signal 205.

In the frequency domain representation of the first signal 205, the dominant frequency 232 of the first brain wave signal 208 may be obtained based on energy of the first signal 205. For instance, if “N %” of energy is greater than other energy % of the first signal 205, then frequency “A” may be obtained as the dominant frequency of the first brain wave signal 208, since a greater amount of energy of the first signal 205 is concentrated in the component corresponding to the frequency “A”.

If the dominant frequency 232 of the first brain wave signal 208 equals the first frequency, the processing unit 203 may determine that the user 202 has gazed at the LED 207. For instance, if the dominant frequency 232 of the first brain wave signal 208 is determined to be 50 Hz and if the first frequency is 50 Hz, then the processing unit 203 may determine that the user 202 has gazed at the LED 207.

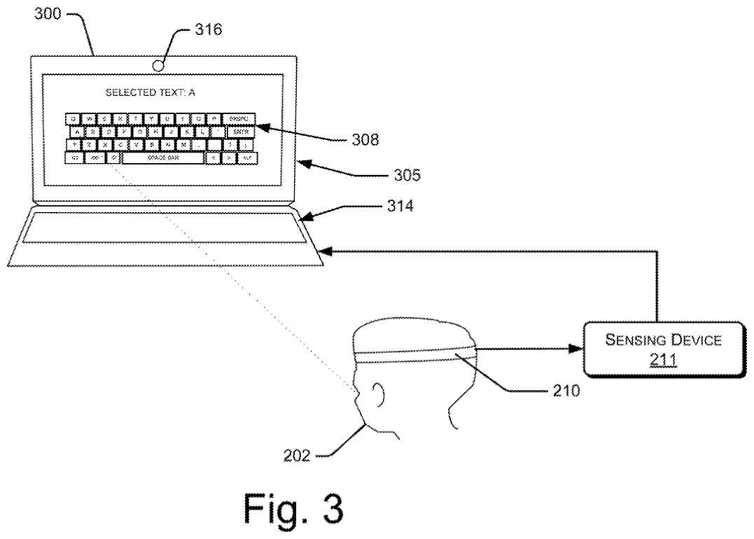

Based on the determination that the user 202 has gazed at the LED 207, the processing unit 203 may identify that the user 202 requests for display of an input interface to provide the input. Subsequently, the processing unit 203 may perform an action to allow user 202 to provide the input, which will be explained in detail with respect to the FIG. 3.

In an example, the processing unit 203 may perform the action if the user 202 has gazed at the LED 207 for a first time period. For instance, to ensure that the user 202 is requesting to display the input interface, and that the gaze at the LED 207 is not an inadvertent gaze at the LED 207, the user 202 may have to gaze at the LED 207 for the first time period. The first time period may be, for example, in a range of 3-5 seconds. Accordingly, as mentioned earlier, the processing unit 203 may process a time-domain representation of the first signal 205, by applying FFT, to obtain the frequency-domain representation of the first signal 205. From the frequency-domain representation of the first signal 205, the dominant frequency 232 of the first brain wave signal 208 may be obtained. If the dominant frequency 232 equals the first frequency of the LED 207 for the first time period, the processing unit 203 may deduce that the user 202 has gazed at the LED 207 to request for display of the input interface. On the other hand, if the processing unit 203 determines that the user 202 has gazed at the LED 207 for a time period less than the first time period, the processing unit 203 may deduce that the gaze at the LED 207 was inadvertent, and may not perform the action to allow providing input.

FIG. 3 illustrates a computing device 300 receiving an input from a user and performing an action corresponding to the input, according to an example implementation of the present subject matter. The computing device 300 may correspond to the computing device 100.

In response to the identification that the user 202 is requesting for display of the input interface, the computing device 300 may perform an action to allow the user 202 to provide the input. The action may be, for example, generation of the input interface for display by a display device 305, which may correspond to the display device 104. The input interface may comprise a plurality of images, which may be keys of a virtual alphanumeric keyboard 308 (interchangeably referred to as the virtual keyboard or the keyboard). Each key of the keyboard 308 can be selected to provide an input, such as a textual input, to the computing device 300.

In an example, each key of the keyboard 308 flickers at a frequency (hereinafter referred to as “flickering frequency”), Further, the flickering frequency of each key may be distinct. For instance, flickering frequency of one key may be different from flickering frequencies of other keys of the keyboard 308. The flickering of a key may be achieved by utilizing a display refresh functionality of the display device 305, which facilitates the display device 305 to repeatedly draw and remove an identical frame of an image several times. The number of times an identical image can be drawn and removed by the display device 305 per second may be referred to as a display refresh rate of the display device 305.

Further, flickering of a key at a flickering frequency may be achieved by drawing a plurality of pixels corresponding to the key for first number of successive frames and not drawing the pixels corresponding to the key for the second number of frames that succeeds the first number of frames. This pattern of drawing and not drawing the pixels may be repeated for a predetermined number of times. For instance, a flickering frequency of 10 Hz of a key in a display device with refresh rate of 60 Hz can be achieved by repeating the following pattern for 10 times per second: drawing a plurality of pixels corresponding to the key for three successive frames and not drawing the pixels corresponding to the key for the following three successive frames. Likewise, a flickering frequency of 30 Hz of a key in a display device with refresh rate of 60 Hz, can be achieved by repeating the following pattern for 30 times per second: drawing a plurality of pixels corresponding to the key for one frame and not drawing the pixels for the successive frame. Accordingly, the pixels may be drawn and removed for a predetermined number of frames for several keys depending on the display refresh rate of the display device 305 and flickering frequency of the respective key. In an example, the virtual keyboard 308 with each key flickering at unique frequency may be achieved by executing an application in the computing device 300.

In an example, the computing device 300 may comprise an electronic ink screen display. The electronic ink screen display may be part of a base unit 314 of the computing device 300 and can display a plurality of images. For instance, the electronic ink screen may dynamically display the keyboard 308 in response to the identification of the request of the user 202 to display the input interface. In addition, the electronic ink screen display may be written on or drawn on using a stylus or hand for providing input to the computing device 300.

Due to the flickering of the images, when the user 202 gazes at a key, a brain wave signal (hereinafter referred to as the second brain wave signal) (not shown in FIG. 3) may be generated in the brain of the user 202. The second brain wave signal may comprise a dominant frequency that corresponds to the flickering frequency of a key that was gazed at by the user 202. The set of electrodes 210 may sense the second brain wave signal and the sensing device 211 may generate a second signal (not shown in FIG. 3) corresponding to the second brain wave signal.

In an example, the second signal may be generated from the second brain wave signal in a manner similar to generation of the first signal explained with reference to FIG. 2. For instance, the second signal may be an amplified, filtered, and digitized version of the second brain wave signal.

In an example, the second brain wave signal may be filtered by the filter (not shown in FIG. 3) of the sensing device 211 to obtain a portion of the second brain wave signal in a beta frequency band (i.e., a frequency range of 12-30 Hz). This is because the flickering frequencies of the keys of the keyboard 308 may be in a beta frequency range, which may prevent the discomfort of the user 202 from perceiving the flicker and preventing the discomfort caused to the user 202 by such perception of flicker.

The second brain wave signal may comprise a plurality of components, where each component has a different frequency, including a dominant frequency (corresponding to the second brain wave signal) and frequencies corresponding to noise. Accordingly, to ease the processing of the second brain wave signal, the filter may filter out unwanted components in the second brain wave signal and may retain the components of the second brain wave signal with frequencies in the beta frequency range.

Further, the processing unit may receive the second signal from the sensing device 211 and may process the second signal corresponding to the second brain wave signal. In a manner similar to processing the first signal explained with reference to FIG. 2, the processing of the second signal may comprise obtaining the frequency-domain representation of the second signal from the time-domain representation. Further, in the frequency-domain representation of the second signal, the dominant frequency of the second brain wave signal may be obtained.

If the dominant frequency of the second brain wave signal equals the flickering frequency of a key, the processing unit may identify that key and determine that the user 202 has gazed at the key. For instance, if the dominant frequency of a second brain wave signal is obtained as 26 Hz and a flickering frequency of a “B” key is 26 Hz, then the processing unit may determine that the user 202 has gazed at the “B” key.

In response to the determination, the processing unit may perform an action corresponding to the selection of the determined key. As an example, the processing unit may generate the key “B” to be displayed by the display device 204 of the computing device 300 if the processing unit determines that the key “B” has been gazed at by the user 202. In such an example, the key “B” may be displayed on the display device 305 at an area of the display device 305 that is different from an area where the keyboard 308 is displayed such that the key “B” and the keyboard 308 are visible to the user 202 simultaneously.

In an example, the processing unit may perform an action corresponding to the selection of the determined key, based on the determination that the user 202 has gazed at a key for a second time period. For instance, to ensure that the user 202 is selecting a key and that the gaze at a key is not an inadvertent gaze at the key, the user 202 may have to gaze at a key for the second time period. In an example, the second time period may be 1-3 seconds. As mentioned earlier, from the frequency-domain representation of the second signal, the dominant frequency of the second brain wave signal may be obtained. If the obtained dominant frequency of the second brain wave signal equals the flickering frequency of a key for the second time period, the processing unit may determine that the user 202 has gazed at the key for the second time period and that the user 202 is selecting the key. On the other hand, if the processing unit has determined that the user 202 has gazed at a key for a time period less than the second time period, the processing unit may determine that the gaze was an inadvertent gaze and may not perform an action corresponding to selection of the key.

In an example, the processing unit may perform further actions after generating the keyboard 308 for display. For instance, the processing unit may remove the keyboard 308, The removal of the generated keyboard 308 may be based on the first signal. For instance, to remove the generated keyboard 308, the user 202 may gaze at the LED 316. The gazing at the LED 316 by the user 202 may cause generation of the first brain wave signal (not shown in FIG. 3) by the brain of the user 202. The first brain wave signal may be sensed by the set of electrodes 210, which may transmit the first brain wave signal to the sensing device 211. The sensing device 211 may generate the first signal corresponding to the first brain wave signal, as mentioned earlier with reference to FIG. 2. Then, the first signal may be received by the processing unit of the computing device 300. The processing unit may process the first signal. For instance, the processing may comprise applying FFT to the first signal to obtain the dominant frequency of the first brain wave signal, if the dominant frequency of the first brain wave signal equals the first frequency, the processing unit may determine that the user 202 has gazed at the LED 316. Further, based on the determination, the processing unit may remove the generated keyboard 308 from the display device 305.

In an example, the processing unit may remove the generated keyboard 308, based on the determination that the user 202 has gazed at the LED 316 for the first time period. For the determination, the dominant frequency of the first brain wave signal may equal the first frequency for the first time period, as mentioned earlier.

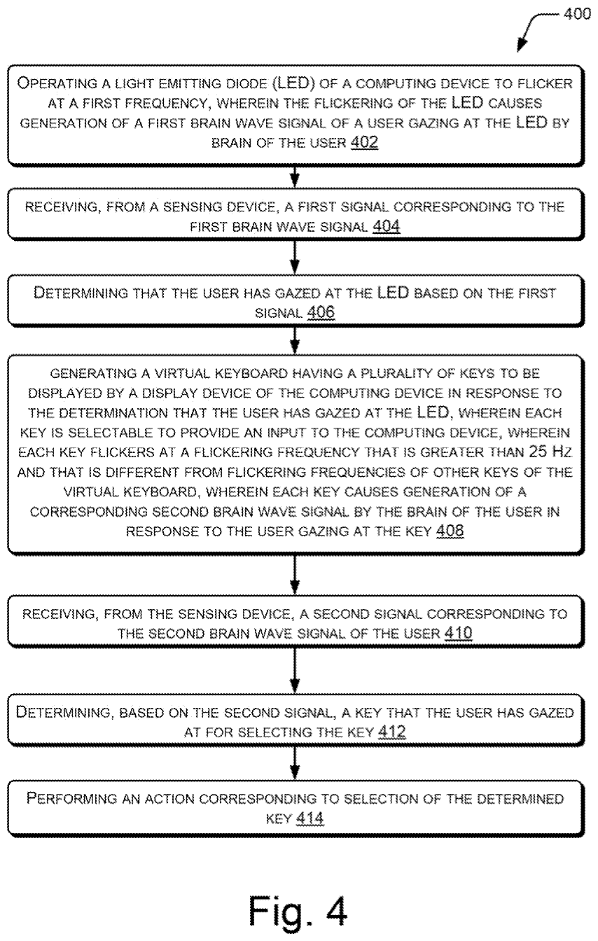

FIG. 4 illustrates a method 400 to receive an input from a user, according to an example implementation of the present subject matter.

The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media.

At step 402, a light emitting diode (LED) of a computing device may be operated to flicker at a first frequency. The LED may be, for example, the LED 207 and the computing device may be, for example, the computing device 100. The flickering of the LED may cause generation of a brain wave signal (hereinafter referred to as the first brain wave signal), corresponding to the first frequency, of a user gazing at the LED by the brain of the user.

In an example, a set of electrodes, such as the set of electrodes 210 may be placed on the head of the user to sense the first brain wave signal. The sensing device, such as the sensing device 211 connected to the set of electrodes may generate a first signal corresponding to the first brain wave signal.

At step 404, the first signal corresponding to the first brain wave signal from the sensing device may be received. The first signal may be, for example, an amplified, filtered and digitized version of the first brain wave signal.

Then, at step 406, based on the first signal, it may be determined that the user has gazed at the LED. For instance, the first signal may be processed by applying Fast Fourier Transform (FFT) to obtain a dominant frequency of the first brain wave signal. If the dominant frequency of the first brain wave signal equals the first frequency, it may be determined that the user has gazed at the LED. For instance, if the dominant frequency of the first brain wave signal is obtained as 50 Hz and if the first frequency is 50 Hz, it may be determined that the user 202 has gazed at the LED 207.

At step 408, in response to the determination that the user has gazed at the LED, a virtual keyboard for display may be generated. The virtual keyboard may be displayed by a display device of the computing device. The display device may be, for example, the display device 104. Each key of the virtual keyboard may be selectable to provide an input to the computing device. Further, each key may flicker at a flickering frequency that may be greater than 25 Hz.

Furthermore, the flickering frequency of each key may be different from flickering frequencies of other keys of the virtual keyboard. For instance, while an “A” key may flicker at a flickering frequency of 25 Hz, a “B” key may flicker at a flickering frequency of 26 Hz. Each key of the keyboard may cause generation of a brain wave signal (hereinafter referred to as a second brain wave signal) by the brain of the user in response to the user gazing at the key.

The second brain wave signal may be sensed by the set of electrodes and a second signal corresponding to the second brain wave signal may be generated by the sensing device. The second signal may be, for example, an amplified, filtered and digitized version of the second brain wave signal. For instance, the second brain wave signal may be amplified to obtain an amplified brain wave signal. The amplified brain wave signal may be filtered to obtain the filtered brain wave signal and the filtered brain wave signal may be digitized to obtain the second signal. In an example, the second signal may be in a beta frequency range (i.e., 12 Hz-30 Hz).

Subsequently, at step 410, the second signal corresponding to the second brain wave signal of the user may be received from the sensing device.

At step 412, based on the second signal, a key that the user has gazed at for selecting the key may be determined. For the determination, the second signal may be processed, by applying FFT, to obtain a dominant frequency of the second brain wave signal. The key having a flickering frequency equaling the dominant frequency of the second brain wave signal may be identified. Subsequently, the identified key may be determined as the key that has been gazed at by the user. For instance, if a dominant frequency of the second brain wave signal is obtained as 25 Hz, the key “A” flickers at a flickering frequency of 25 Hz, then it may be identified that the dominant frequency equals the flickering frequency of the key “A” and it may be determined that the user has gazed at the key “A”.

Then, at step 414, an action corresponding to selection of the determined key may be performed. In an example, a character corresponding to the determined key may be generated for display by the display device. For instance, if it has been determined that a key “A’ has been selected by the user (i.e., the user has gazed at key “A”), then the character “A” may be displayed on the display device.

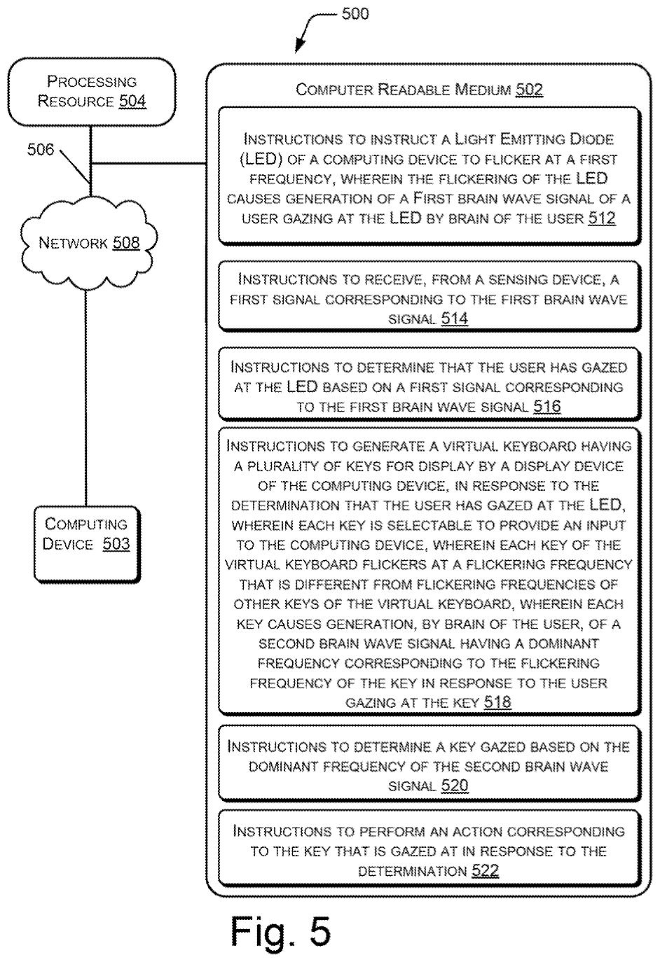

FIG. 5 illustrates a computing environment, implementing a non-transitory computer-readable medium to receive an input, according to an example implementation of the present subject matter.

In an example, the non-transitory computer-readable medium 502 may be utilized by the computing device 503. The computing device 503 may correspond to the computing device 100, The computing device 503 may be implemented in a public networking environment or a private networking environment. In an example, the computing environment 500 may include a processing resource 504 communicatively coupled to the non-transitory computer-readable medium 502 through a communication link 506.

In an example, the processing resource 504 may be implemented in a device, such as the computing device 503. The processing resource 504 may be the processing unit 102, or the processing unit 203. The non-transitory computer-readable medium 502 may be, for example, an internal memory device of the computing device 503 or an external memory device. In an implementation, the communication link 506 may be a direct communication link, such as any memory read/write interface. In another implementation, the communication link 506 may be an indirect communication link, such as a network interface. In such a case, the processing resource 504 may access the non-transitory computer-readable medium 502 through a network 508. The network 508 may be a single network or a combination of multiple networks and may use a variety of different communication protocols. The processing resource 504 and the non-transitory computer-readable medium 502 may also be communicatively coupled to the computing device 503 over the network 508.

In an example implementation, the non-transitory computer-readable medium 502 includes a set of computer-readable instructions to perform an action in response to providing input to the computing device 503. The set of computer-readable instructions can be accessed by the processing resource 504 through the communication link 506 and subsequently executed to perform acts to provide feedback to the actuating object.

Referring to FIG. 5, in an example, the non-transitory computer-readable medium 502 includes instructions 512 that cause the processing resource 504 to instruct a Light Emitting Diode (LED) of a computing device 503 to flicker at a first frequency. The LED may be, for example, the LED 207. The flickering of the LED may cause generation of a first brain wave signal of a user gazing at the LED by the brain of the user.

The non-transitory computer-readable medium 502 includes instructions 514 that cause the processing resource 504 to receive, from a sensing device, a first signal corresponding to the first brain wave signal. The sensing device may be, for example, the sensing device 211. As an example, the first brain wave signal may be sensed by a set of electrodes, such as the set of electrodes 210 placed on the head of the user and the first brain wave signal may be received by the sensing device from the set of electrodes. The first signal may be generated by the sensing device based on the first brain wave signal. For instance, the first brain wave signal may be amplified, filtered and digitized to obtain the first signal. Accordingly, it may be said that the first signal corresponds to the first brain wave signal.

The non-transitory computer-readable medium 502 further includes instructions 516 that cause the processing resource 504 to determine that the user has gazed at the LED based on a first signal corresponding to the first brain wave signal.

The non-transitory computer-readable medium 502 further includes instructions 518 that cause the processing resource 504 to generate a virtual keyboard for display by a display device of the computing device 503, in response to the determination that the user has gazed at the LED. The display device may be, for example, the display device 104, the display device 204 or the display device 305. The virtual keyboard may have a plurality of keys. Each key of the keyboard may be selectable to provide an input to the computing device 503. For instance, the input may be a textual input. Further, each key of the virtual keyboard flickers at a flickering frequency that is different from flickering frequencies of other keys of the virtual keyboard. For instance, an “A” key may flicker at a flickering frequency of 25 Hz and a “B” key may flicker at a flickering frequency of 26 Hz. Furthermore, in response to the user gazing at the key, each key may cause generation of a second brain wave signal by the brain of the user. The second brain have signal may have a dominant frequency corresponding to the flickering frequency of the key. For instance, if a key flickers at a flickering frequency of 25 HZ, and when the user gazes at the key, a second brain wave signal having a dominant frequency of 25 Hz may be generated by the brain of the user.

In an example, the non-transitory computer-readable medium 502 further includes instructions that cause the processing resource 504 to generate the virtual keyboard for display by the display device of the computing device 503, in response to the determination that the user has gazed at the LED for the predetermined time period. For instance, if it is determined that the user has gazed at the LED for the predetermined time period (e.g., 4 sec), then the virtual keyboard may be generated for display by the display device of the computing device 503.

For the determination, the first signal corresponding to the first brain wave signal may be processed by applying EFT to obtain a dominant frequency of the first brain wave signal. Further, in response to the dominant frequency of the first brain wave signal equaling the first frequency for a predetermined time period, it may be determined that the user has gazed at the LED for the predetermined time period. For instance, if the dominant frequency of the first brain wave signal is obtained as 50 Hz for the predetermined time period (e.g., 4 sec), which may be equal to a flickering frequency of the LED i.e., the first frequency, then it may be determined that the user has gazed at the LED for the predetermined time period of 4 sec. The predetermined time period may be, for example, the first time period, as explained with reference to FIG. 2.

The non-transitory computer-readable medium 502 further includes instructions 520 that cause the processing resource 504 to determine a key gazed at based on the dominant frequency of the second brain wave signal.

In an example, for the determination, a second signal corresponding to the second brain wave signal may be received from the sensing device. As an example, the second brain wave signal may be sensed by the set of electrodes and the second brain wave signal may be received by the sensing device from the set of electrodes. The second signal received from the sensing device may be an amplified, filtered and digitized version of the second brain wave signal.

Then, the second signal corresponding to the second brain wave signal may be processed by applying FFT to obtain the dominant frequency of the second brain wave signal. The key having a flickering frequency equaling the dominant frequency of the second brain wave signal may be identified and the identified key may be determined as the key that the user has gazed at. For instance, if a dominant frequency of the second brain wave signal is obtained as 25 Hz, the key “A” flickers at a flickering frequency of 25 Hz, then it may be identified that the dominant frequency equals the flickering frequency of the key “A” and it may be determined that the user has gazed at the key “A”.

The non-transitory computer-readable medium 502 further includes instructions 522 that cause the processing resource 504 to perform an action corresponding to the key that is gazed at in response to the determination. For instance, if it is determined that the user has gazed at a key “A”, then letter “A” may be displayed on the display device.

In an example, the non-transitory computer-readable medium 502, upon generating the virtual keyboard, further includes instructions that cause the processing resource 504 to remove the generated virtual keyboard from the display device.

In an example, for removing the generated virtual keyboard, the first signal, which is received from the sensing device may be processed, by applying FFT, to obtain the dominant frequency of the first brain wave signal. Further, in response to the dominant frequency of the first brain wave signal equaling the first frequency, it may be determined that the user has gazed at the LED. Based on the determination, the generated virtual keyboard may be removed from the display device.

The present subject matter provides an, efficient and reliable technique to provide inputs to the computing devices. For instance, since the present subject matter allows receiving inputs by the computing device based on brain wave signals of a user, the present subject matter eliminates the usage of input devices, such as keyboard. Further, the usage of hands for providing input to the computing device can be obviated.

Although examples and implementations of present subject matter have been described in language specific to structural features and/or methods, it is to be understood that the present subject matter is not necessarily limited to the specific features or methods described, Rather, the specific features and methods are disclosed and explained in the context of a few example implementations of the present subject matter.

What is claimed is:

1. A computing device comprising:
a processing unit to:
identify a request of a user to display an input interface to provide an input to the computing device based on receipt of a first signal corresponding to a gaze of the user at a predetermined region of the computing device;
generate the input interface comprising a plurality of images for display, in response to the identification of the request of the user, wherein each image is a key of a virtual keypad and is selectable to provide an input to the computing device, wherein each image flickers at a flickering frequency that is different from flickering frequencies of other images of the plurality of images, wherein each image causes generation of a brain wave signal corresponding to the flickering frequency of the image by a brain of the user in response to the user gazing at the image;
receive a second signal corresponding to the brain wave signal from a sensing device;
determine, based on the second signal, an image that the user has gazed at for selecting the image; and
perform an action corresponding to selection of the determined image; and
a display device to display the plurality of images.

2. The computing device of claim 1, wherein the predetermined region comprises a light emitting diode (LED) flickering at a predetermined frequency, and wherein the first signal corresponds to the predetermined frequency.

3. The computing device of claim 1, wherein the virtual keypad is a virtual alphanumeric keyboard.

4. The computing device of claim 1, wherein the display device is one of: a liquid crystal display (LCD), a light emitting diode (LED) display, and an electronic ink display.

5. The computing device of claim 1, wherein each of the plurality of images flicker at a flickering frequency greater or equal to than 25 Hz.

6. A method comprising:
operating a light emitting diode (LED) of a computing device to flicker at a first frequency, wherein the flickering of the LED causes generation of a first brain wave signal of a user gazing at the LED by a brain of the user;
receiving, from a sensing device, a first signal corresponding to the first brain wave signal;
determining that the user has gazed at the LED based on the first signal;
generating a virtual keyboard having a plurality of keys to be displayed by a display device of the computing device in response to the determination that the user has gazed at the LED, wherein each key is selectable to provide an input to the computing device, wherein each key flickers at a flickering frequency that is greater than 25 Hz and that is different from flickering frequencies of other keys of the virtual keyboard, wherein each key causes generation of a corresponding second brain wave signal by the brain of the user in response to the user gazing at the key;
receiving, from the sensing device, a second signal corresponding to the second brain wave signal of the user;
determining, based on the second signal, a key that the user gazed at for selecting the key; and
performing an action corresponding to selection of the determined key.

7. The method of claim 6, comprising:
processing, by applying Fast Fourier Transform (FFT), the first signal to obtain a dominant frequency of the first brain wave signal; and
determining that the user has gazed at the LED in response to the dominant frequency equaling the first frequency.

8. The method of claim 6, comprising:
amplifying the second brain wave signal to obtain an amplified second brain wave signal;
filtering the amplified second brain wave signal to obtain a filtered second brain wave signal; and
digitizing the filtered second brain wave signal to obtain the second signal.

9. The method of claim 6, wherein the second signal is in a beta frequency band.

10. The method of claim 6, comprising:
processing, by applying Fast Fourier Transform (FFT), the second signal to obtain a dominant frequency of the second brain wave signal;
identifying the key having a flickering frequency equaling the dominant frequency of the second brain wave signal; and
determining the identified key as the key that the user gazed at.

11. The method of claim 6, wherein performing the action comprises:
generating a character corresponding to the determined key to be displayed by the display device.

12. A non-transitory computer-readable medium comprising instructions, the instructions being executable by a processing resource to:
instruct a Light Emitting Diode (LED) of a computing device to flicker at a first frequency, wherein the flickering of the LED causes generation of a first brain wave signal of a user gazing at the LED by a brain of the user;
receive, from a sensing device, a first signal corresponding to the first brain wave signal;
determine that the user has gazed at the LED based on the first signal corresponding to the first brain wave signal;
generate a virtual keyboard having a plurality of keys for display by a display device of the computing device, in response to the determination that the user has gazed at the LED, wherein each key is selectable to provide an input to the computing device, wherein each key of the virtual keyboard flickers at a flickering frequency that is different from flickering frequencies of other keys of the virtual keyboard, wherein each key causes generation, by the brain of the user, of a second brain wave signal having a dominant frequency corresponding to the flickering frequency of the key in response to the user gazing at the key;
determine a key gazed at based on the dominant frequency of the second brain wave signal; and
perform an action corresponding to the key that is gazed at in response to the determination.

13. The non-transitory computer-readable medium of claim 12, wherein the instructions are executable by the processing resource to:
process, by applying Fast Fourier Transform (FFT), the first signal to obtain a dominant frequency of the first brain wave signal;
determine that the user has gazed at the LED for a predetermined time period in response to the dominant frequency of the first brain wave signal equaling the first frequency for the predetermined time period; and
generate the virtual keyboard for display by the display device of the computing device, in response to the determination that the user has gazed at the LED for the predetermined time period.

14. The non-transitory computer readable medium of claim 12, wherein the instructions are executable by the processing resource to:
receive, from the sensing device, a second signal corresponding to the second brain wave signal;
process, by applying Fast Fourier Transform (FFT), the second signal corresponding to the second brain wave signal to obtain the dominant frequency of the second brain wave signal;
identify the key having a flickering frequency equaling the dominant frequency of the second brain wave signal; and
determine the identified key as the key that the user has gazed at.

15. The non-transitory computer-readable medium of claim 12, wherein upon generating the virtual keyboard, the instructions are executable by the processing resource to:
receive, from the sensing device, the first signal, which corresponds to the first brain wave signal;
process, by applying Fast Fourier Transform (FFT), the first signal to obtain a dominant frequency of the first brain wave signal;
determine that the user has gazed at the LED based on the dominant frequency of the first brain wave signal equaling the first frequency; and
remove the generated virtual keyboard from the display device in response to the determination that the user has gazed at the LED.
